(19) United States
(12) Patent Application Publication
(10) Pub. No.: US 2011/0247740 A1
(43) Pub. Date: Oct. 13, 2011

(54) PNEUMATIC TIRE, TIRE MOLD AND MANUFACTURING METHOD OF PNEUMATIC TIRE

(75) Inventor: Masaaki Ohara, Osaka (JP)

(73) Assignee: TOYO TIRE & RUBBER CO., LTD., Osaka (JP)

(21) Appl. No.: 13/053,370

(22) Filed: Mar. 22, 2011

(30) Foreign Application Priority Data
Apr. 8, 2010 (JP) 2010-089633

(51) Int. Cl. B60C 3/00; B29D 30/72; B29C 59/00

(52) U.S. Cl. 152/454; 264/326; 425/28.1

(57) ABSTRACT

A pneumatic tire has a rough surface portion which is provided on an outer surface of a side wall portion. In the rough surface portion, a maximum height Rz is equal to or more than 4 μm and a skewness Rsk satisfies Rsk>0.

### BACKGROUND OF THE INVENTION

1. Field of the Invention

The present invention relates to a pneumatic tire, a tire mold for cure molding the tire, and a manufacturing method of the pneumatic tire.

2. Description of the Related Art

In cure molding of a tire, an outer surface of an uncured tire is likely to be stuck to a tire molding surface of a tire mold, and an adhesive failure as shown in FIG. 8 may be generated by a rubber flow defect caused thereby. The adhesive failure is recognized as a region which is continuously peeled or depressed in a circumferential direction in the tire outer surface, and is remarkably generated particularly in a side wall portion. Further, such a rubber flow defect promotes an air residual between the tire molding surface and the tire outer surface, and causes a molding sink called a lightness or a bare generated on the outer surface of the cured tire.

In Japanese Unexamined Patent Publication No. H06-106921, there is described a pneumatic tire structured such that an outer surface of a side wall portion is partitioned into a plurality of fan-shaped regions which are adjacent in a circumferential direction, and a difference of surface roughness is made equal to or more than 50 μm between the adjacent fan-shaped regions, for making inconspicuous a stripe-like irregularity trace generated by a joint portion of a carcass ply. Further, the publication No. H06-106921 describes changing a surface roughness of a tire molding surface of a tire mold for molding such a tire, and it is considered to be possible to improve a flow property of the rubber by suppressing an adhesion of an uncured tire at the time of cure molding, as far as the surface roughness corresponding to the fan-shaped region is rough.

However, in the tire mold mentioned above, since a micro convex portion included in the region in which the surface roughness is rough forms a micro concave portion which is deep and sharp to the tire side, a strain tends to be concentrated to the portion, and there is a problem that it becomes an initial point of the crack on the tire outer surface. However, if the surface roughness of the region is lowered, it has an effect on prevention of a crack, however, since a flow resistance of the uncured. rubber with respect to the tire molding surface is increased, a rubber flow defect is generated at the time of the cure molding and an appearance fault such as an adhesive failure or the like is generated. As mentioned above, with regard to the surface roughness of the tire molding surface, it has been difficult to secure the flow property of the rubber and to prevent the crack on the tire outer surface at the same time.

In Japanese Unexamined Patent Publication No. 2009-190526, there is described a pneumatic tire structured by forming an irregularity portion in which a mean roughness Ra is between 6 and 50 μm and a skewness Rsk of a roughness profile satisfies Rsk<0, on an outer surface of a tread portion of the tire. However, in the structure mentioned above, since a sharp micro concave portion is formed on the outer surface of the tire, there is a risk that it becomes an initial point of the crack after all. As a matter of course, this tire intends to improve a wet brake performance, and does not suggest a solving means with respect to the appearance fault such as the adhesion defect generated in the side wall portion.

Further, the publication No. 2009-190526 describes that the pneumatic tire mentioned above can be manufactured by using a tire mold provided with the irregularity portion in which the mean roughness Ra is between 6 and 50 μm and the skewness Rsk of the roughness profile satisfies Rsk<0. However, according to a situation where the irregularity portion on the tire side is formed by transcribing the irregularity portion on the mold side, it is considered to be correct that the skewness Rsk satisfies Rsk>0 in the irregularity portion on the mold side.

### SUMMARY OF THE INVENTION

The present invention has been made in view of the above situation, and an object of the present invention is to provide a pneumatic tire which can prevent a crack in a tire outer surface of a side wall portion while securing a flow property of a rubber in the side wall portion, a tire mold, and a manufacturing method of the pneumatic tire.

As a result of devoting himself to a study, the inventor of the present invention has found that a crack on an outer surface of a tire can be effectively prevented while securing a flow property of a rubber, by providing a rough surface portion in which a maximum height Rz and a skewness Rsk come to specific ranges, on an outer surface of a side wall portion of a pneumatic tire. The present invention has been made based on the technical knowledge mentioned above, and the object thereof can be achieved by the following structure.

That is, a pneumatic tire in accordance with the present invention comprises a rough surface portion in which a maximum height Rz is equal to or more than 4 μm and a skewness Rsk satisfies Rsk>0, the rough surface portion being provided on an outer surface of a side wall portion. In this pneumatic tire, since the maximum height Rz is equal to or more than 4 μm in the rough surface portion of the outer surface of the side wall portion, the rough surface portion is formed rough correspondingly, and it is possible to secure the flow property of the rubber by suppressing the adhesion of the uncured rubber at the time of the cure molding. At the same time, since the skewness Rsk of the roughness profile satisfies Rsk>0, a sharpness of the micro concave portion included in the rough surface portion is suppressed, and it is possible to effectively prevent a crack from being generated, by suppressing a concentration of a strain at the position. Although the appearance fault caused by the rubber flow defect is remarkable in the side wall portion, it is possible to effectively prevent the appearance fault by the rough surface portion as mentioned above.

The maximum height Rz and the skewness Rsk in the present invention respectively correspond to the maximum height roughness Rz and the skewness Rsk of the roughness profile defined in JISB0601:2001, and are based on the regulation. Further, rules and procedures for an assessment and characteristics of instruments are based on the provisions of JISB0633:2001 and JISB0651:2001. A sampling length and an evaluation length are defined in correspondence to a surface texture of the rough surface portion, and in the case where the maximum height Rz is equal to or less than 10 μm, the sampling length is 0.8 mm, the evaluation length is 4 mm, in the case where the maximum height Rz exceeds 10 μm and is equal to or less than 50 μm, the sampling length is 2.5 mm, the evaluation length is 12.5 mm, and in the case where the maximum height Rz exceeds 50 μm, the sampling length is 8 mm, the evaluation length is 40 mm.

In the pneumatic tire in accordance with the present invention, it is preferable that the rough surface portion is structured such that a protruding valley depth Rvk satisfies Rvk<3 μm. According to such a structure, since the micro concave portion included in the rough surface portion becomes shallower and gentler, it is possible to more reliably prevent the crack on the outer surface of the tire.

The protruding valley depth Rvk in the present invention, and the protruding peak height Rpk mentioned below respectively correspond to the protruding valley depth Rvk and the protruding peak height Rpk defined in JISB0671-2:2002, and are based on the regulation. Further, characteristics of the instruments, a measuring condition and the like are based on the provisions of JISB0651:2001 and JISB0671-1:2002, and the cutoff value λc is 0.8 mm, the evaluation length is 4 mm.

Further, a tire mold in accordance with the present invention comprises a rough surface molding portion in which a maximum height Rz is equal to or more than 4 μm and a skewness Rsk satisfies Rsk<0, the rough surface molding portion being provided in a region molding a side wall portion in a tire molding surface. In this tire mold, since the maximum height Rz is equal to or more than 4 μm in the rough surface molding portion formed in the region molding the side wall portion, the rough surface molding portion is formed rough correspondingly, and it is possible to suppress the adhesion of the uncured rubber at the time of the cure molding so as to secure the flow property of the rubber. At the same time, since the skewness Rsk satisfies Rsk<0, the sharpness of the micro convex portion included in the rough surface molding portion is suppressed, and it is possible to effectively prevent the crack from being generated, by making the micro concave portion formed in the outer surface of the tire gentle.

In the tire mold in accordance with the present invention, it is preferable that the rough surface molding portion is structured such that a protruding peak height Rpk satisfies Rpk<3 μm. According to the structure mentioned above, since the micro convex portion included in the rough surface molding portion becomes lower and gentler, it is possible to more reliably prevent the crack on the outer surface of the tire by making the micro concave portion formed on the outer surface of the tire shallower and gentler.

Further, a manufacturing method of the pneumatic tire according to the present invention comprises a step of cure molding the tire by using any of the tire molds described above. In this method, it is possible to inhibit the appearance fault such as the adhesion defect due to the rubber flow defect or the like from being generated, by the tire molding surface provided with the rough surface molding portion as mentioned above. Further, it is possible to effectively prevent the crack on the outer surface of the tire by suppressing the sharpness of the micro convex portion included in the rough surface molding portion and making the micro concave portion formed in the tire side gentler.

### BRIEF DESCRIPTION OF THE DRAWINGS

FIG. 1 is a perspective view showing one example of a pneumatic tire according to the present invention;

FIG. 2 is a diagram showing a roughness profile for explaining a maximum height Rz;

FIG. 3 is a diagram showing a roughness profile for explaining a skewness Rsk;

FIG. 4 is a diagram showing a roughness profile for explaining a protruding valley depth Rvk and protruding peak height Rpk;

FIG. 5 is a vertical cross sectional view schematically showing an example of a tire mold according to the present invention;

FIG. 6 is a cross sectional view as seen from an arrow A-A in FIG. 5;

FIG. 7 is a cross sectional view explaining a setting of an uncured tire to the tire mold; and

FIG. 8 is a perspective view of a pneumatic tire for explaining an adhesive failure.

### DETAILED DESCRIPTION OF THE PREFERRED EMBODIMENTS

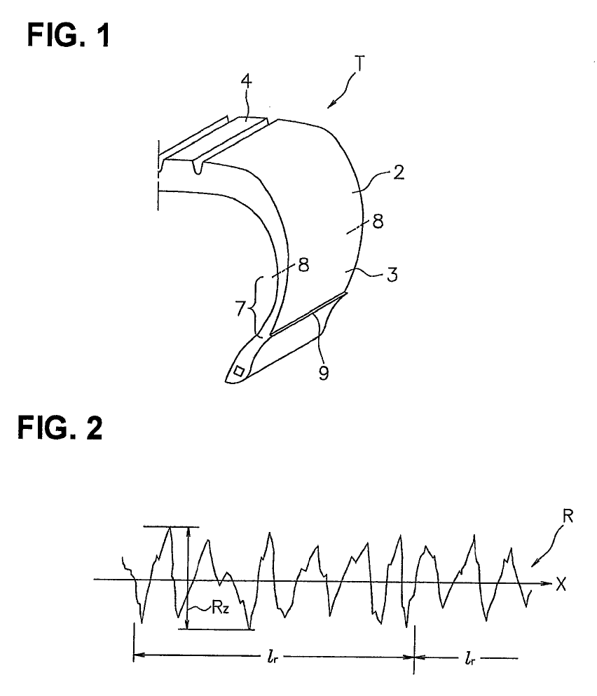

An embodiment of the present invention will be explained with reference to the drawings. FIG. 1 shows an example of a pneumatic tire according to the present invention. The pneumatic tire T is provided with a side wall portion 3 extending outward in a tire diametrical direction from a bead portion seating on a rim, and a tread portion 4 configuring a tread surface while being connected to an outer end of the side wall portion 3. The pneumatic tire according to the present invention can be constructed in the same manner as the normal pneumatic tire except for being provided with a rough surface portion 2 mentioned below, and is provided with a carcass and a belt which are not illustrated, in its inside.

The tire T is provided with the rough surface portion 2 in which a maximum height Rz and a skewness Rsk are set to specific ranges, on an outer surface of the side wall portion 3. The rough surface portion 2 is provided at at least a part of the outer surface of the side wall portion 3, and is preferably formed in an annular region along a tire circumferential direction. In the present embodiment, the rough surface portion 2 is formed in a region corresponding to a region 6 (refer to FIG. 6) of a tire molding surface 10 mentioned below. There is a case where a design such as a logo or a side protector is formed in the region, however, the rough surface portion 2 may be formed optionally therein.

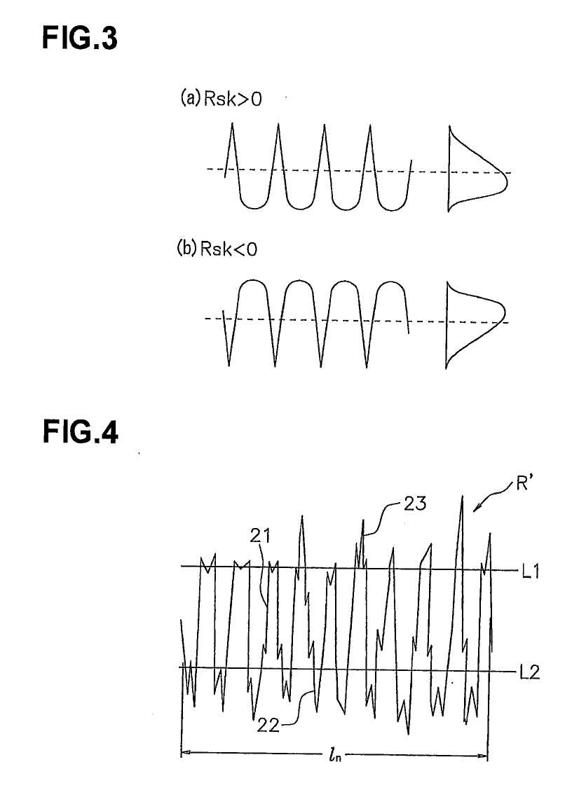

The rough surface portion 2 is structured such that the maximum height Rz is equal to or more than 4 μm, and the skewness Rsk satisfies Rsk>0. As shown in FIG. 2, the maximum height Rz is a sum of a maximum value of a peak height and a maximum value of a valley depth in the roughness profile R, and can be determined as an average value of measured data obtained per five continuous sampling lengths lr. Further, as shown in FIGS. 3(a) and 3(b), the skewness Rsk expresses a degree of deflection (a scale of asymmetry of a probability density function in a height direction) , and the valley of the roughness profile is comparatively gently formed, in the rough surface portion 2 in which the skewness Rsk becomes a positive value (Rsk>0). FIGS. 3(a) and 3(b) are schematically expressed, and an actual roughness profile becomes such an uneven shape that a height is irregular such as FIG. 2.

Since the maximum height Rz is equal to or more than 4 μm in the rough surface portion 2, a surface texture becomes rough correspondingly. As a result, a flow resistance of the uncured rubber with respect to the tire molding surface becomes small at the time of the cure molding, and it is possible to secure a flow property of the rubber. On the contrary, in the case where the maximum height Rz is less than 4 μm, the outer surface of the side wall portion 3 is likely to be stuck to the tire molding surface at the time of the cure molding so as to cause a rubber flow defect, and there is a risk that an appearance fault is generated in the outer surface of the tire after the cure.

At the same time, in the rough surface portion 2, since the skewness Rsk satisfies Rsk>0, a sharpness of the micro concave portion included in the rough surface portion 2 is suppressed as shown in FIG. 3(a), and it is possible to effectively prevent a crack from being generated. On the contrary, if the skewness Rsk of the rough surface portion satisfies Rsk<0, the valley of the roughness profile is tapered as shown in FIG. 3(b), and a sharp micro concave portion to which a strain tends to be concentrated is formed. Accordingly, for example, if a strain repeatedly acts under an ozone ambient atmosphere, there is fear that a crack is generated beginning at the position so as to be actualized on the outer surface of the tire.

The maximum height Rz of the rough surface portion 2 is set between 4 and 30 μm for roughening the surface texture appropriately, is further preferably set between 4 and 15 μm, is more preferably set between 7 and 30 μm in the case of taking into consideration a mold forming property for forming the rough surface portion 2, and is particularly preferably set between 10 and 25 μm. Further, the skewness Rsk of the rough surface portion 2 is preferably set between 0.3 and 1.2 in the case of taking into consideration the mold forming property for forming the rough surface portion 2, as well as reliably preventing the crack on the outer surface of the tire, and is more preferably set between 0.8 and 1.2.

Since the rubber flow defect at the time of cure molding is remarkable in the side wall portion 3, it is possible to accurately secure the flow property of the rubber by forming the rough surface portion 2 on the outer surface of the side wall portion 3, whereby it is possible to more reliably prevent the adhesive failure from being generated. Such a rubber flow defect is particularly remarkable in a region 7 from a maximum width position 8 of the tire to a rim line 9, and it is desirable to form the rough surface portion 2 at least in the region 7. Of course, it is optional to form the rough surface portion 2 on the outer surface of the other position such as the tread portion 4 or the like, and the rough surface portion 2 may be formed wholly on the outer surface of the tire.

The rough surface portion 2 is preferably structured such that the protruding valley depth Rvk satisfies Rvk<3 μm. In a roughness profile R′ shown in FIG. 4, reference symbol L1 denotes an upper level of a core 21, reference symbol L2 denotes a lower level of the core 21, reference symbol ln denotes an evaluation length, and the protruding valley depth Rvk is an average depth of protruding valleys 22 which are below the core 21. Accordingly, since the protruding valley depth Rvk satisfies Rvk<3 μm, the protruding valleys 22 of the roughness profile R′ are regulated shallow, the micro concave portion included in the rough surface portion 2 becomes shallower and gentler, and it is possible to suppress the concentration of the strain so as to reliably prevent the crack.

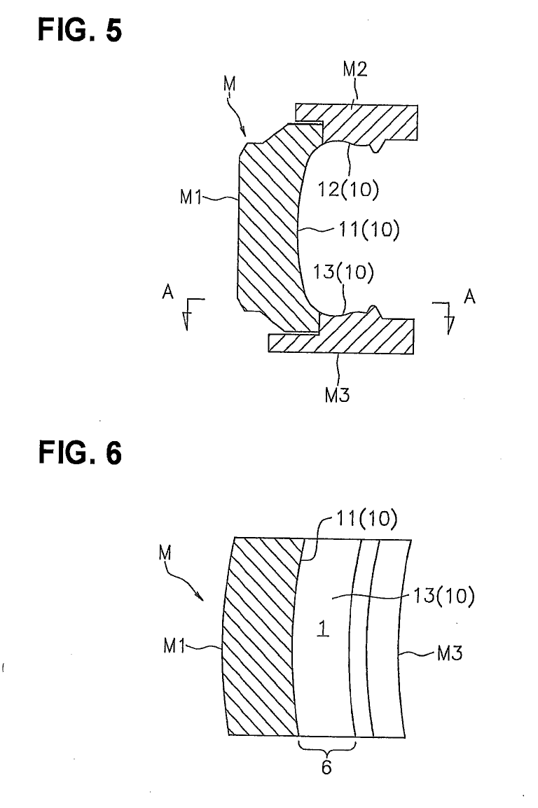

Next, a description will be given of a method of manufacturing the pneumatic tire T. Since the manufacturing method of the pneumatic tire according to the present invention can be carried out in the same manner as the conventional tire manufacturing step, except for a step of cure molding the tire, a description will be given focusing on a cure molding step. The manufacturing method of the pneumatic tire includes a step of cure molding the tire by using a tire mold M (hereinafter, referred to as a mold M) corresponding to a cure metal mold for a tire shown in FIG. 5.

At the time of the cure molding, the uncured tire is set to the mold M by setting the tire axial direction to up and down, and the outer surface of the tire is brought into contact with the tire molding surface 10. The mold M is provided with a tread mold portion M1 for molding the tread portion, and side mold portions M2 and M3 for molding the side wall portions, and inner surfaces 11 to 13 of the respective mold portions construct the tire molding surface 10. Although not illustrated, an irregularity shape corresponding to the tread pattern is formed in the inner surface 11 of the tread mold portion M1.

The mold M is provided with the rough surface molding portion in which the maximum height Rz and the skewness Rsk are set to the specific ranges, in the tire molding surface 10. In the present embodiment, as shown in FIG. 6, the rough surface molding portion 1 is formed in the region 6 for molding the side wall portion (corresponding to the side wall portion 3 in FIG. 1) in the lower side of the tire molding surface 10, and the region 6 extends over a part of the inner surface 11 of the tread mold portion M1 and the inner surface 13 of the side mold portion M3. In the rough surface molding portion 1, the maximum height Rz is equal to or more than 4 μm and the skewness Rsk satisfies Rsk<0. In the rough surface molding portion 1 in which the skewness Rsk becomes the negative value (Rsk<0) as mentioned above, a peak of the roughness profile becomes comparatively gentle as shown in FIG. 3(b).

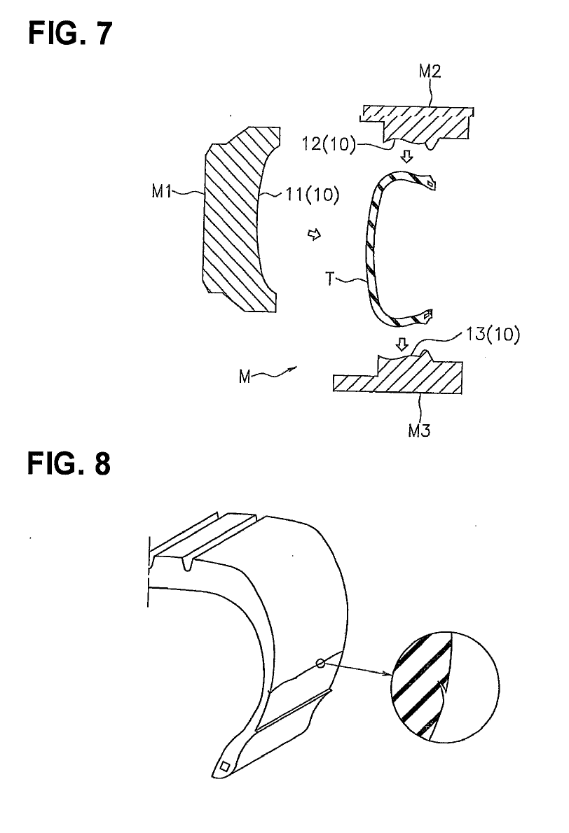

In the cure molding step, the uncured tire T before the cure molding is set as shown in FIG. 7, the tire molding surface 10 is thereafter pressed against the outer surface of the tire by clamping the mold M as shown in FIG. 5, and heat and pressure are applied to the tire T. At this time, in the rough surface molding portion 1, since the maximum height Rz is equal to or more than 4 μm, the flow property of the rubber is secured, and it is possible to inhibit the appearance fault such as the adhesive failure or the like caused by the rubber flow defect. Further, on the outer surface of the tire T, the rough surface molding portion 1 in which the skewness Rsk satisfies Rsk<0 is transcribed, and the rough surface portion 2 in which the micro concave portion becomes comparatively gentle is formed, whereby it is possible to effectively prevent the crack from being generated.

In the pneumatic tire T manufactured through such a cure molding step, the rough surface portion 2 is molded on the outer surface of the side wall portion 3 as shown in FIG. 1. Since the rough surface portion 2 is molded by transcribing the rough surface molding portion 1, the maximum height Rz becomes equal to or more than 4 μm, and the skewness Rsk satisfies Rsk>0, in its surface texture.

In the present embodiment, since the rough surface molding portion 1 is formed in the region for molding the side wall portion of the tire molding surface 10 as shown in FIG. 6, it is possible to accurately prevent the appearance fault such as the adhesive failure or the like, in the side wall portion 3 in which the rubber flow defect tends to be generated. For the reason mentioned above, it is desirable that the rough surface molding portion 1 is formed at least in the region (corresponding to the region 7 in FIG. 1) from the maximum width position of the tire to the rim line in the tire molding surface 10.

The rough surface molding portion 1 is preferably structured such that a protruding peak height Rpk satisfies Rpk<3 μm. As shown in FIG. 4, the protruding peak height Rpk expresses an average height of a protruding peak 23 which are above the core 21 of the roughness profile R′, and since this satisfies Rpk<3 μm, the protruding peaks 23 of the roughness profile R′ are regulated low. Accordingly, the micro concave portion included in the rough surface portion 2 of the molded tire T becomes shallower and gentler, and it is possible to suppress the concentration of the strain so as to reliably prevent the crack on the outer surface of the tire.

The rough surface molding portion 1 is not particularly limited in its working method and a working condition, as far as the surface texture mentioned above can be obtained. As the working method of the rough surface molding portion 1, there can be exemplified a sandblast work of blowing sand or an abrasives, and an etching work of blowing an etching reagent having FeCl3 as a main component or the like, and it is useful to lightly polish by a sandpaper or the like after these works.

FIG. 6 shows an example in which the rough surface molding portion 1 is formed uniformly in the tire circumferential direction, however, it may be formed non-uniformly. However, if the rough surface molding portion is formed non-uniformly such as the mold described in Japanese Unexamined Patent Publication No. H06-106921, it becomes difficult to control a parameter referring to the surface texture such as the maximum height Rz or the like, and an uncomfortable feeling may be given to the appearance by generating a difference in gloss on the outer surface of the tire. Accordingly, it is preferable that the rough surface molding portion 1 is formed uniformly.

At the time of forming the rough surface molding portion 1 uniformly in the tire circumferential direction, it is preferable to extend the stripe line for working in the rough surface molding portion 1 in a spiral shape along the tire circumferential direction. Accordingly, since the micro irregularity of the rough surface molding portion 1 extends in the spiral shape along the tire circumferential direction, it is possible to easily prevent the lightness on the outer surface of the tire from being generated, by efficiently discharging the air at the time of the cure molding.

The present invention is not limited to the embodiment mentioned above, but can be variously modified and changed within the scope of the present invention. In the embodiment mentioned above, there is shown the example in which the tire molding surface is constructed by three mold portions, however, the structure is not limited thereto, and it may be constructed, for example, by a pair of mold portions which are divided into two sections in the center of the tread portion. Further, an inner side in the tire diametrical direction of the side mold portion may be provided with a bead ring fitting the bead portion of the tire as an independent member.

### EXAMPLE

In order to specifically show the structure and the effect of the present invention, the pneumatic tires (tire size 11R22.5) provided with the rough surface portions having the various surface textures on the outer surface of the side wall portion were cure molded, and conditions that the appearance fault and the crack are generated were evaluated.

As an evaluation with respect to the appearance fault, the tires after the cure molding were observed in increments of ten, and presence or absence of the adhesive failure (the rubber interface) or the generation of the lightness due to the rubber flow defect was searched. The evaluation was carried out by paying attention to a degree of the generation and the number of the generation, and setting the case where the recognized number of the generation of the depression scratch or the appearance fault due to the adhesive failure is three (30%) or more to “x”, the case where the recognized number of the generation of the comparatively shallow stripe-shaped scratch is less than three (30%) to “Δ”, and the case where no problem is generated to “◯”.

Further, a crack test was carried out by using three tires after the cure molding. In the crack test, a length of the crack was measured after traveling for 400 hours, by rotating the tire in which 70% of a normal internal pressure described in standard (JATMA, TRA or the like) to which the tire is applied is filled, and to which a load which is 120% of a normal load is applied, on a drum at a speed of 40 km/h under an ambient atmosphere having an ozone concentration 40 pphm. Results are shown by an index number in the case of setting a result of Evaluation example 2 to 100, and the smaller the numerical value is, the more excellent it indicates.

TABLE 1

| | | | Protruding | | |
|---|---|---|---|---|---|
| | Max- | | valley | | |
| | imum | | depth | | |
| | height | Skewness | Rvk | Appearance | Crack |
| | Rz (μm) | Rsk | (μm) | fault | test |
| Evaluation | 3.18 | 0.12 | 0.69 | x | 79 |
| example 1 | | | | | |
| Evaluation | 6.08 | −0.12 | 1.82 | x | 100 |
| example 2 | | | | | |
| Evaluation | 5.79 | −0.08 | 1.34 | Δ | 108 |
| example 3 | | | | | |
| Evaluation | 15.65 | −0.43 | 6.28 | Δ | 151 |
| example 4 | | | | | |
| Evaluation | 17.58 | 0.09 | 4.23 | ∘ | 117 |
| example 5 | | | | | |
| Evaluation | 23.34 | 0.95 | 2.85 | ∘ | 93 |
| example 6 | | | | | |
| Evaluation | 26.22 | −0.21 | 9.35 | Δ | 172 |
| example 7 | | | | | |
| Evaluation | 31.25 | 1.43 | 5.23 | ∘ | 104 |
| example 8 | | | | | |

As shown in Table 1, if the maximum height Rz is less than 4 μm, the rubber flow defect is caused, and the appearance fault tends to be generated (Evaluation example 1). Further, if the skewness Rsk of the rough surface portion satisfies Rsk<0, the crack cannot be sufficiently prevented (Evaluation examples 4 and 7). On the contrary, if the maximum height Rz and the skewness Rsk are set to the specific ranges, the crack of the outer surface of the tire can be efficiently prevented while securing the flow property of the rubber (Evaluation examples 5, 6 and 8). Particularly, in the case where the protruding valley depth Rvk is also set to the specific range, it is possible to effectively prevent the crack (Evaluation example 6).

What is claimed is:

1. A pneumatic tire comprising a rough surface portion in which a maximum height Rz is equal to or more than 4 μm and a skewness Rsk satisfies Rsk>0, the rough surface portion being provided on an outer surface of a side wall portion.

2. The pneumatic tire according to claim 1, wherein the rough surface portion is structured such that a protruding valley depth Rvk satisfies Rvk<3 μm.

3. A tire mold comprising a rough surface molding portion in which a maximum height Rz is equal to or more than 4 μm and a skewness Rsk satisfies Rsk<0, the rough surface molding portion being provided in a region molding a side wall portion in a tire molding surface.

4. The tire mold according to claim 3, wherein the rough surface molding portion is structured such that a protruding peak height Rpk satisfies Rpk<3 μm.

5. A manufacturing method of a pneumatic tire comprising a step of cure molding a tire by using the tire mold according to claim 3.
